(19) United States
(12) Patent Application Publication
(10) Pub. No.: US 2025/0367599 A1
(43) Pub. Date: Dec. 4, 2025

(54) System For Separating Carbon Dioxide From A Gas Flow

(71) Applicants: Volkswagen Aktiengesellschaft, Wolfsburg (DE); MAN Energy Solutions SE, Augsburg (DE)

(72) Inventors: Martin HOFER, Braunschweig (DE); Marcel WIEGEL, Gardelegen / OT Sachau (DE); Peter KAWELKE, Wolfsburg (DE); Stephan WEBER, Herten (DE)

(73) Assignees: Volkswagen Aktiengesellschaft, Wolfsburg (DE); MAN Energy Solutions SE, Augsburg (DE)

(21) Appl. No.: 19/214,697

(22) Filed: May 21, 2025

(30) Foreign Application Priority Data
May 29, 2024 (DE) 102024115079.3

(51) Int. Cl. B01D 53/62; B01D 53/26

(52) U.S. Cl. CPC B01D 53/62; B01D 53/263; B01D 2257/504; B01D 2257/80

(57) ABSTRACT

The disclosure relates to a system for separating carbon dioxide from a gas flow, in particular from an air flow. The system comprises at least one first functional unit and at least one second functional unit connected downstream of the first functional unit in the flow direction of a main air flow through the system. It is provided that the first functional unit has a first number of functional modules and the second functional unit has a second number of functional modules, wherein the second number is higher than the first number.

### CROSS-REFERENCE TO RELATED APPLICATIONS

This application claims priority to German Patent Application No. DE 10 2024 115 079.3, filed on May 29, 2024 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a system for separating carbon dioxide from a gas flow, in particular from an air flow.

Plants and methods for capturing carbon dioxide from the ambient air are known to the inventors. Such a capture can be carried out using what is known as the “direct air capture method,” wherein the carbon dioxide can be captured directly from the ambient air, stored or fed into a further process. Carbon dioxide can be separated from the ambient air using different sorbents.

Typically, chemisorbents and/or physisorbents are used to separate carbon dioxide. Amine-based chemisorbents have the problem of aging and degradation when the material comes into contact with oxygen at temperatures above approx. 60° C. This can occur during the desorption phase at temperatures of around 100° C. if countermeasures are not implemented, for example an inert atmosphere in the system using water vapor or other gases. These protective measures are laborious and expensive. Physisorbents, such as zeolites, have the problem that the affinity of the sorbent material for water (vapor) is higher than for carbon dioxide, which means that the ambient air must first be dried before being supplied to an adsorption space in which the zeolite material is arranged. Drying the air in this way is also laborious and expensive.

In order to achieve efficient separation of carbon dioxide from the ambient air, plants for the separation of carbon dioxide may be operated using renewable energies, in particular hydropower, geothermal energy, wind power, or solar energy. Operation with hydropower would be beneficial, as this can be provided continuously and reliably. However, the potential for generating energy from hydropower is limited to corresponding watercourses and is already almost fully utilized in many regions, such that an expansion of the use of hydropower is limited. Geothermal energy can also be used continuously and is therefore an option at certain locations. Solar energy and wind power can essentially be used regardless of location, but their use is limited by the orbit of the sun and/or the weather conditions at the location.

A disadvantage of such plants, however, is that the adsorption and desorption processes for carbon dioxide and any drying process of the ambient air upstream of the adsorption are influenced by different parameters, such as the ambient temperature, humidity, temperature and carbon dioxide content of the ambient air.

### SUMMARY

A need exists to increase the efficiency of a system for separating carbon dioxide from a gas flow.

The need is addressed by the subject matter of the independent claim(s). Embodiments of the invention are described in the dependent claims, the following description, and the drawings.

### BRIEF DESCRIPTION OF THE DRAWINGS

FIG. 1 shows an example system for separating carbon dioxide from a gas flow, in particular from an air flow;

FIG. 2 shows an example pre-conditioning unit and a drying unit of a system for separating carbon dioxide from a gas flow and a flow distribution chamber for distributing a gas flow;

FIG. 3 shows an example pipeline for discharging a gas flow at an outlet of a functional unit; and

FIG. 4 shows an example functional unit, in particular a pre-conditioning unit or a drying unit of a system for separating carbon dioxide from a gas flow.

### DESCRIPTION

The details of one or more embodiments are set forth in the accompanying drawing and the description below. Other features will be apparent from the description, drawing, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, a system for separating carbon dioxide from a gas flow, in particular from an air flow, is provided. The system comprises at least one first functional unit and at least one second functional unit connected downstream of the first functional unit in the flow direction of a main air flow through the system. It is provided that the first functional unit has a first number n of functional modules and the second functional unit has a second number m of functional modules, wherein the second number m is higher than the first number n. A ‘functional unit’ in this context is also referred to as a ‘functional assembly’ and a ‘functional module’ is also referred to as a ‘module assembly’ or ‘subassembly’.

The system according to embodiments allows for a simple, modular design in which the flow resistances and thus the thermal power losses are minimized. This allows for particularly energy-efficient separation of carbon dioxide from the gas flow.

The dependent claims discuss various embodiments.

In some embodiments, it is provided that the first functional unit is a pre-conditioning unit, also referred herein as ‘pre-conditioner’, having at least one filter module and the second functional unit is a drying unit, also referred herein as ‘dryer’, having at least two drying modules. When using a physisorbent as the sorbent material, the gas flow must be dried before the sorption process. In addition to the filter unit, the pre-conditioning unit may have one or more sorbent elements for pre-drying the gas flow. Particularly efficient drying of the gas flow is possible by dividing it among multiple drying modules. Dividing the gas flow among multiple drying modules is also beneficial, since not all drying modules may always be available in continuous process control. This ensures that sufficient drying of the gas flow is achieved, even if a drying module is being regenerated in parallel and is not available for drying the gas flow.

In some embodiments, it is provided that the first functional unit is a drying unit having at least one drying module and the second functional unit is a sorption unit, also referred to herein as ‘sorption enclosure’ or ‘sorption assembly’, having at least two sorption modules. This makes it easy to adapt the required drying capacity to the performance of the sorption modules, thus avoiding overcapacities and providing the most efficient system possible.

Alternatively, it is provided that the first functional unit is a sorption unit having at least one sorption module and the second functional unit is a storage unit having at least two storage modules. This means that the required storage capacity can be easily adapted to the performance of the sorption modules, thus avoiding overcapacities and providing the most efficient system possible.

In some embodiments, it is provided that the second functional unit has twice as many functional modules as the first functional unit. This makes it particularly easy to divide a gas flow exiting the functional modules of the first functional unit among the functional modules of the subsequent functional unit in the flow direction.

In some embodiments, it is provided that a flow distribution chamber is arranged between the first functional unit and the second functional unit in order to divide a gas flow exiting a functional module of the first functional unit among multiple functional modules of the second functional unit. A flow diverter element allows for particularly efficient division of the gas flow with low flow losses. In addition, a flow deflector element can increase the design freedom, which means that the required installation space can be reduced without increasing the flow resistance.

In some embodiments, it is provided that a distance between the first functional unit and the second functional unit is at most 2 meters, or for example at most 1.5 meters, or for example in the range of from 1 to 1.5 meters. This allows for a particularly compact design of the system, which minimizes the required installation space and costs.

It is particularly beneficial if the distance between the pre-conditioning unit and the drying unit is at most 2 meters, or for example at most 1.5 meters, or for example between one meter and 1.5 meters.

In some embodiments, it is provided that the system has a return line with which a dried, carbon dioxide-reduced gas flow is drawn off downstream of the sorption unit and fed back to the pre-conditioning unit. This makes it easier to regenerate, in particular, additional sorption elements in the pre-conditioning unit for pre-drying the gas flow.

According to some embodiments, it is provided that an inlet of a functional unit is formed or arranged perpendicularly to an outlet of the same functional unit. As a result, the installation space can be minimized. In particular, the overall height can be reduced such that the functional modules can be easily stacked one on top of the other.

In some embodiments, it is further provided that the system has three functional units following on from one another in the flow direction of a main air flow through the system. The first functional unit has a first number n of functional modules, the second functional unit has a second number m of functional modules which is greater than the number of functional modules of the first functional unit, and the third functional unit has a third number k of functional modules which is greater than the number m of functional modules of the second functional unit. Such an arrangement allows for a simple modular design in which the flow resistances and thus the thermal power losses are minimized. This allows for particularly energy-efficient separation of carbon dioxide from the gas flow.

It is particularly beneficial if the first functional unit is a pre-conditioning unit, the second functional unit is a drying unit, and the third functional unit is a sorption unit. This allows for optimum separation of carbon dioxide with a physisorbent in the sorption unit.

In some embodiments, it is provided that the system has a filter unit, a drying unit following on from the filter unit in the flow direction of a main air flow through the system, and a sorption unit following on from the drying unit, wherein a flow guide element is arranged between the filter unit and the drying unit and/or between the drying unit and the sorption unit in order to minimize flow losses due to vortex formation and/or dead water zones. This minimizes the flow losses at the transition from one functional unit to the subsequent functional unit, which can further increase the overall efficiency of the system.

Reference will now be made to the drawings in which the various elements of embodiments will be given numerical designations and in which further embodiments will be discussed.

In the embodiments described herein, the described components of the embodiments each represent individual features that are to be considered independent of one another, in the combination as shown or described, and in combinations other than shown or described. In addition, the described embodiments can also be supplemented by features other than those described.

Specific references to components, process steps, and other elements are not intended to be limiting. The FIGS. Are schematic and not necessarily to scale.

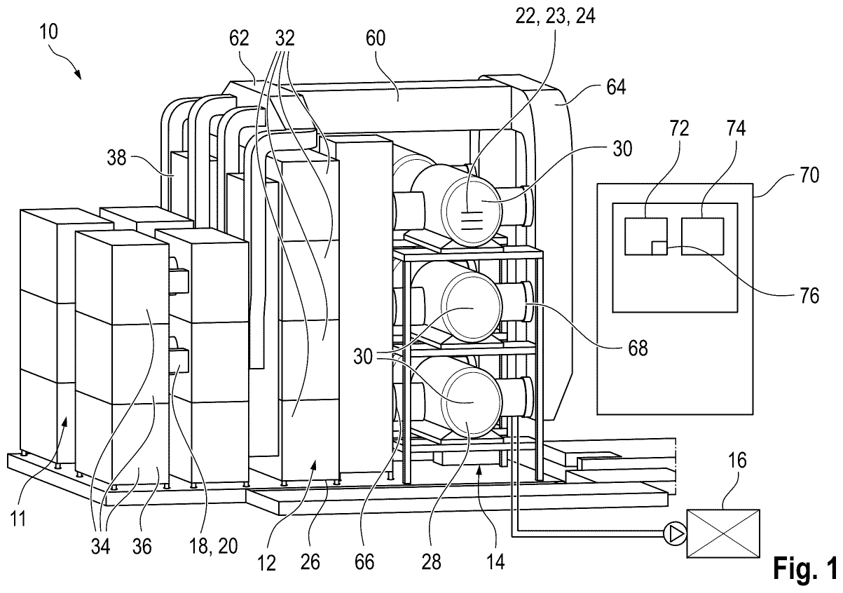

FIG. 1 shows a system 10 for separating carbon dioxide from a gas flow, in particular from the ambient air. A gas flow with a certain residual moisture content is fed to the system 10 and carbon dioxide and water are removed from this gas flow. An exhaust air flow flows out of the system 10, which has a gas that is partially dried and reduced in terms of carbon dioxide compared to the incoming gases.

The system comprises a pre-conditioning unit 11, in which impurities are filtered out of the gas flow. In particular, impurities such as particles or sand, but also pollen, flying seeds, or insects can be filtered out of the gas flow.

The system 10 comprises a drying unit 12, in which the residual moisture contained is at least partially removed from the gas flow. The drying unit 12 comprises multiple drying modules 32 for absorbing the moisture from the gas flow. For example, a hydrophilic material such as silica gel can be used as the desiccant for the drying unit 12. In principle, any drying material that is suitable for absorbing moisture from the air can be used. In particular, a sorbent material 22, in particular a physisorbent 23, may also be provided as a desiccant in the drying unit 12. For example, a desiccant is used which is regenerated by appropriate process control after absorbing the humidity and is available for the process again. The aim is to achieve a degree of drying of the gas flow at which the residual moisture in the air has a dew point of at most −30° C., or for example −50° C., or for example at most a dew point of −60° C.

The system 10 also comprises a sorption unit 14, in which the carbon dioxide from the gas flow, in particular from the ambient air, is bound. The carbon dioxide in the dried gas flow is stored in a sorbent material 22, in particular in a physisorbent 23, for example in a zeolite material 24. The sorption unit 14 comprises one or more sorption modules 30, each of which has a cylindrical housing. Alternatively, the sorption modules 30 may also have geometries that deviate from a cylindrical shape. The housing has a lateral surface, wherein an inlet opening 66 is formed on a first side of the lateral surface and an outlet opening 68 is formed on a second side of the lateral surface opposite the first side.

In addition, the system 10 has a storage unit 16, in which the carbon dioxide separated from the gas flow in the sorption unit 14 is stored in concentrated form. Alternatively, the desorbed carbon dioxide can also be fed directly for further use.

The system 10 further comprises a conveying element 18, in particular a blower 20, with which a gas flow, in particular an air flow, is passed through the drying unit 12 and then through the sorption unit 14.

The gas flow is for example dried in a first process chamber 26, which may be separated from the environment in a substantially gas-tight manner by closure elements, in particular by flaps. In the exemplary embodiment shown, the first process chamber 26 has an inlet flap and an outlet flap. A heating element may be arranged in the first process chamber 26 in order to manipulate the air temperature in the drying unit 12 or else in the first process chamber 26. Furthermore, sensors for detecting a temperature, a pressure, a carbon dioxide concentration, a flow velocity, and/or a relative or absolute humidity of the gas flow may be arranged in the first process chamber 26 or else in the drying unit 12.

A conveying element 18, in particular a blower 20, is provided in the pre-conditioning unit 11 or between the pre-conditioning unit 11 and the drying unit 12 in order to convey a gas flow, in particular an air flow of the ambient air, first through the drying unit 12 and then through the sorption unit 14. The conveying element 18 has a drive unit whose power can be adjusted accordingly via a power controller. Alternatively, the conveying element 18 can also be arranged in a channel for feeding the air to the system 10 or a channel for discharging the air from the system 10.

The pre-conditioning unit 11 is connected to the drying unit 12 via a flow distribution chamber 56 in order to ensure the best possible drying of the gas flow. The flow distribution chamber 56 makes it possible to supply different drying modules 32 that are in the adsorption stage at the relevant point in time.

A return line 60, 64 branches off downstream of the sorption unit 14, with which return line dry, carbon dioxide-reduced gas can be fed back into the pre-conditioning unit 11 and into the drying unit 12 in order to increase the energy efficiency when drying the gas flow. For this purpose, a distributor 62 is provided in order to divide the dried, carbon dioxide-reduced gas flow among the sorption elements located in the pre-conditioning unit 11 and to regenerate them. The recirculated gas flow then exits the system from the side of the filter modules 34. Furthermore, a partial gas flow is branched off from the return line 60, 64 in order to regenerate the drying modules 32 of the drying unit 12.

The system 10 is for example supplied with electricity from renewable energy sources such as wind or solar power, so as not to generate any additional carbon dioxide emissions during operation. For this purpose, a wind turbine and/or a solar system, in particular a solar thermal system or a photovoltaic system, is provided to supply the system with renewable energy.

The system 10 further has a control unit 70 having a memory unit 72 and a computing unit 74, wherein a computer program code 76 is stored in the memory unit 72, which computer program code is configured, when executed by the computing unit 74 of the control unit 70, to control the operation of the system 10 for separating carbon dioxide from the gas flow, in particular from the ambient air. The control unit 70 may be connected to a data center via a data connection, which data center provides the system 10 with data for controlling the system 10 or exchanges data therewith.

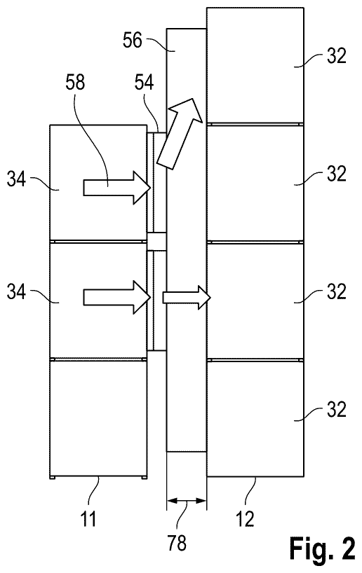

FIG. 2 shows a pre-conditioning unit 11 and a drying unit 12 of a system 10 according to the teachings herein for separating carbon dioxide and a flow distribution chamber 56 for distributing a main air flow 58. The pre-conditioning unit 11 has multiple filter modules 34. FIG. 2 shows a pre-conditioning unit 11 having two filter modules 34, which are stacked one on top of the other.

FIG. 2 also shows a drying unit 12 having four drying modules 32, which are also arranged one above the other. An intermediate element 54 and a flow distribution chamber 56 are arranged between the pre-conditioning unit 11 and the drying unit 12, with which flow distribution chamber a main air flow 58 exiting the filter modules 34 of the pre-conditioning unit 11 is deflected and divided among the drying modules 32.

The air is distributed from a lower number n of upstream functional modules 34, in particular filter modules 34, to a higher number m, in particular double the number m=2n, of subsequent functional modules 32, in particular drying modules 32.

The system 10 for separating carbon dioxide should be as short as possible in order to make the best possible use of the installation space. Fixed channels are unfavorable, since the gas flow is introduced into different functional modules 30, 32 at different times.

The functional modules 32, 34 may, for example, be transport containers adapted to the function. The distance 78 and thus the space between the functional modules 32, 34 is for example between 1 m and 1.5 m. Further flow-optimizing modifications to reduce sharp deflections or dead water zones are possible.

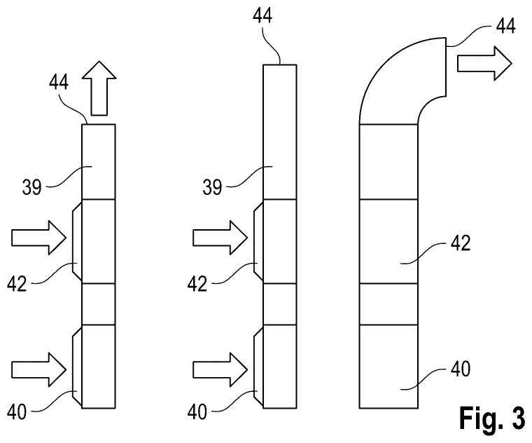

FIG. 3 shows a pipeline 39 for a system 10 for separating carbon dioxide from a gas flow. The pipeline 39 has a first opening 40 and a second opening 42, with which outgoing exhaust air flows from two functionally identical functional modules of a functional unit 11 are received and exit the pipeline 39 again at an outlet opening 44.

The exhaust air can be discharged from the side of the same containers into which the fresh air is drawn. In another embodiment, the air may also exit from another system component, which is also at the same height as the intake.

The concept shown in FIG. 3 is used, in particular, to avoid back suction from a gas flow that is already free of carbon dioxide, for example in unfavorable wind conditions. The exhaust air is guided in a vertical channel above the level of the uppermost intake and only then fed into the environment. Alternatively, a further deflection may take place in the direction away from the intake.

This is also particularly relevant in connection with a large system or plant that has multiple systems according to the teachings herein for separating carbon dioxide, because if the exhaust air is not guided upwards, it could be drawn in by a neighboring system and affect operation thereof.

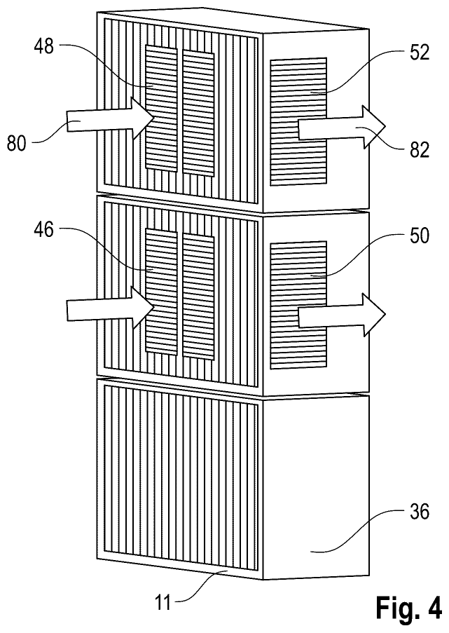

FIG. 4 shows a further functional unit 11, in particular a pre-conditioning unit 11 having multiple functional modules 34. Each functional module 34 of the functional unit 11 has two inlets 46, 48 for a gas flow 80 entering the functional module 34 and outlets 50, 52 arranged perpendicularly to the inlets 46, 48 in each case for a gas flow 82 exiting the functional unit 34.

### LIST OF REFERENCE NUMERALS

10 System for separating carbon dioxide
11 Pre-conditioner/Pre-conditioning unit
12 Dryer/Drying unit
14 Sorption unit/Sorption enclosure
16 Storage/Storage unit
18 Conveying element/Conveyor
20 Blower
22 Sorbent material
23 Physisorbent
24 Zeolite material
26 First process chamber
28 Second process chamber
30 Sorption module/Sorption subassembly
32 Drying module/Drying subassembly
34 Filter module/Filter subassembly
36 Third process chamber
38 Pipeline
39 Pipeline
40 First opening
42 Second opening
44 Outlet opening
46 First inlet
48 Second inlet
50 First outlet
52 Second outlet
54 Intermediate element
56 Flow distribution chamber
58 Main air flow
60 First return line
62 Distributor
64 Second return line
66 Inlet opening
68 Outlet opening
70 Control unit/Processor
72 Memory unit/Memory
74 Computing unit/Computer
76 Computer program code
78 Distance
80 Incoming gas flow
82 Outgoing gas flow

The invention has been described in the preceding using various example embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The terms “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

1. A system for separating carbon dioxide from a gas flow, comprising:
at least one first functional unit; and
at least one second functional unit connected downstream of the first functional unit in the flow direction of a main air flow, wherein
the first functional unit has a first number of functional modules and the second functional unit has a second number of functional modules, wherein the second number is higher than the first number.

2. The system of claim 1, wherein the first functional unit is a pre-conditioner having at least one filter module and the second functional unit is a dryer having at least two drying modules.

3. The system of claim 1, wherein the first functional unit is a dryer having at least one drying module and the second functional unit is a sorption unit having at least two sorption modules.

4. The system of claim 1, wherein the first functional unit is a sorption unit having at least one sorption module and the second functional unit is a storage having at least two storage modules.

5. The system of claim 1, wherein the second functional unit has twice as many functional modules as the first functional unit.

6. The system of claim 1, wherein a flow distribution chamber is arranged between the first functional unit and the second functional unit in order to divide a gas flow exiting a functional module of the first functional unit among multiple functional modules of the second functional unit.

7. The system of claim 1, wherein a distance between the first functional unit and the second functional unit is at most 2 m.

8. The system of claim 1, wherein the system has a return line with which a dried, carbon dioxide-reduced gas flow is drawn off downstream of the sorption unit and fed back to the pre-conditioner.

9. The system of claim 1, wherein an inlet of a functional unit is formed or arranged perpendicularly to an outlet of the same functional unit.

10. The system of claim 1, wherein a pipeline is provided at the gas flow outlets of the first functional unit, wherein the pipeline has at least two openings for the common discharge of a gas flow of the functional modules directly upstream of the pipeline.

11. The system of claim 10, wherein the first functional unit is a pre-conditioner and the second functional unit is a dryer.

12. The system of claim 1, wherein the system has three functional units following on from one another in the flow direction of a main air flow through the system, wherein the first functional unit has a first number of functional modules, the second functional unit has a second number of functional modules which is greater than the number of functional modules of the first functional unit, and the third functional unit has a third number of functional modules which is greater than the number of functional modules of the second functional unit.

13. The system of claim 12, wherein the first functional unit is a pre-conditioner, the second functional unit is a dryer, and the third functional unit is a sorption unit.

14. The system of claim 1, wherein the system has a pre-conditioner, a dryer following on from the pre-conditioner in the flow direction of a main air flow through the system, and a sorption unit following on from the dryer, wherein a flow distribution chamber is arranged between the pre-conditioner and the dryer and/or between the dryer and the sorption unit in order to minimize flow losses due to vortex formation and/or dead water zones.

15. The system of claim 2, wherein the second functional unit has twice as many functional modules as the first functional unit.

16. The system of claim 3, wherein the second functional unit has twice as many functional modules as the first functional unit.

17. The system of claim 4, wherein the second functional unit has twice as many functional modules as the first functional unit.

18. The system of claim 2, wherein a flow distribution chamber is arranged between the first functional unit and the second functional unit in order to divide a gas flow exiting a functional module of the first functional unit among multiple functional modules of the second functional unit.

19. The system of claim 3, wherein a flow distribution chamber is arranged between the first functional unit and the second functional unit in order to divide a gas flow exiting a functional module of the first functional unit among multiple functional modules of the second functional unit.

20. The system of claim 4, wherein a flow distribution chamber is arranged between the first functional unit and the second functional unit in order to divide a gas flow exiting a functional module of the first functional unit among multiple functional modules of the second functional unit.
